(19) United States
(12) Patent Application Publication
(10) Pub. No.: US 2017/0188740 A1
(43) Pub. Date: Jul. 6, 2017

(54) Collapsible silicone pot

(71) Applicant: Jiamen Huichengfen Industrial Co., Ltd, Jiangmen City (CN)

(72) Inventor: Li Shicheng, Zhuhai City (CN)

(21) Appl. No.: 15/360,095

(22) Filed: Nov. 23, 2016

(30) Foreign Application Priority Data
Nov. 25, 2015 (CN) 201520953516.8

(51) Int. Cl. A47J 27/00; A47J 36/06; A47J 45/08; A47J 36/02

(52) U.S. Cl. CPC A47J 27/002; A47J 36/02; A47J 36/06; A47J 45/08

(57) ABSTRACT

A foldable silicone pot species, including a pot body including a thermally conductive substrate, the lower end of a silicone annular wall comprising a heat conducting bottom fixed in connection with the lower end of the annular wall of silicone and the upper end of the annular wall connected to a pot opening border. The small size body is composed of silicone material that is safe, non-toxic, environmentally friendly, resistant to high temperatures, can be cleaned and disinfected and is light weight. The cyclic silicone wall structure can be folded so that it is easy to store or carry.

### CROSS-REFERENCE TO REALTED APPLICATION

The present application is based on and claims the benefit of Chinese Utility Patent Application No. 201520953516.8, filed Nov. 25, 2015 and published as Patent No. CN 205410816 U on Aug. 3, 2016, the content of which is hereby incorporated by reference in its entirety.

### BACKGROUND

The present disclosure relates to the food and drink containers and more specifically, a collapsible silicone cooking pot for convenient storage and transportation.

Currently, the cutlery and cooking supplies are generally made of ceramic, metal or plastic, and the supply's shape is fixed. Cleaning up and storage takes up a lot of space when using these traditional dishes and cooking supplies. There are further deficiencies with current kitchen supplies. The use of superimposed placement (stackable goods) may contaminate the inner wall of the lower cooking utensils or supplies. Ceramics sometimes inadvertently break. Metal supplies have higher production costs and when they collide they create harsh noises. Plastics generally contain bisphenol A, which precipitates at high temperatures. This precipitation may lead to adverse health effects such as endocrine disorders. The majority of these existing dishes or cooking items are often bulky, heavy, and inconvenient to carry and have a limited number of uses.

### SUMMARY

In order to overcome the deficiencies of the prior art, the present disclosure provides a safe, non-toxic, environmentally friendly, high temperature resistant, easily cleanable and disinfectable, light weight, small size, easily stored or carried foldable, silicone pot.

The present disclosure is directed to a collapsible or foldable silicone pot, comprising a silicone pot body that is foldable or collapsible, the body comprises a thermally conductive bottom and a thermally conductive top rim. For example, the main body is a generally annular wall and a lower end of the annular wall terminates in connection to a bottom portion configured for positioning over a heat source and comprised of a thermally conductive material. The lower end of the annular foldable wall is fixed in connection to the thermally conductive bottom and the upper end of the annular wall of the silicone pot is fixed to a reinforcing pot opening, such as an aluminum ring. The pots can be provided in a set of a plurality of pots having different sizes (e.g., diameters and liquid capacities) such that when each pot is collapsed into a generally compact and flattened state, one pot fits inside another pot with a larger diameter and so on. The pots are configured for nesting with additional pots of substantially the same construction but in varying sizes and capacities.

Further, the annular wall may be a unitary or monolithic silicone wall that is an injection molded component and that may be an integrally molded flexible silicone wall for the pot. The silicone wall is configured for folding or collapsing in an “accordion style” manner.

Further, the annular wall may comprise a thick layer of silica gel and a thin wall layer, the thick layer of the thin wall and the interval between consecutive layers.

Further, the thin wall of the annular wall of the silica layer when unfolded, or expanded, allows the pot to hold a liquid for heating, expanding and collapsing the pot allows the pot to move between positions, such as from an open, large pot to a small bucket like shape to a cone-like structure to a flat structure.

Further, the annular wall of the thermally conductive silicone bottom part may be connected to a thick layer, which is a thick layer of the annular wall of the highest height thickness of silica layer.

Further, the annular wall of silica gel in a thick layer above the lower edge of the upper edge of a radius is greater than the radius at the bottom of the thick layer.

Further, the mouth of the pot rim may be comprised of a metal ring fixedly secured to the upper portion of the annular wall and provided with one or more fixed handles, the handles may be metal handles also coated with silicone for heat insulation.

Further, the handle is provided with insulation.

As a modification of the above aspect, further comprising a pot cover, the pot cover body may be a transparent glass cover, the edge of the cover glass may be coated with a silicone seal layer, and on top of the silica glass cover is a fixed handle.

The pot has the advantages that a pot body composed of a silicone material is safe, non-toxic, environmentally healthy, high temperature resistant, can be cleaned and disinfected, light weight and of small size. In addition, as a cyclic silicone wall structure can be folded, the overall structural design is practical, it is easy to store or to carry, and it is lightweight.

### DESCRIPTION OF THE DRAWINGS

FIG. 1 is a schematic view of the structure of the utility model;

FIG. 2 is a folded state of the utility model in a schematic pot body;

FIG. 3 is a new cross-sectional view of the utility.

### DETAILED DESCRIPTION

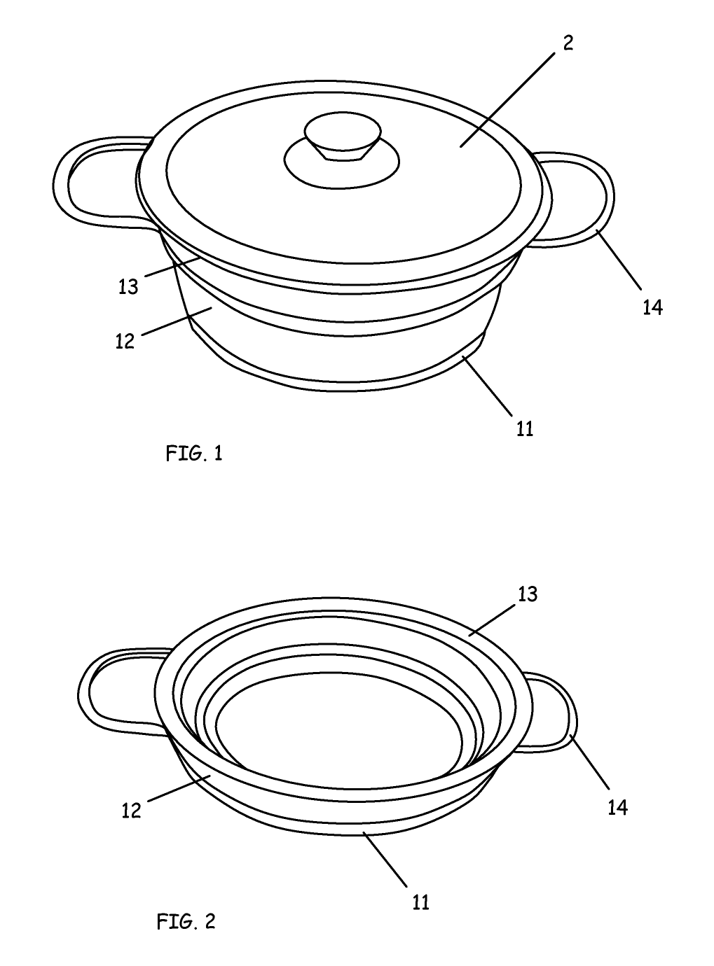

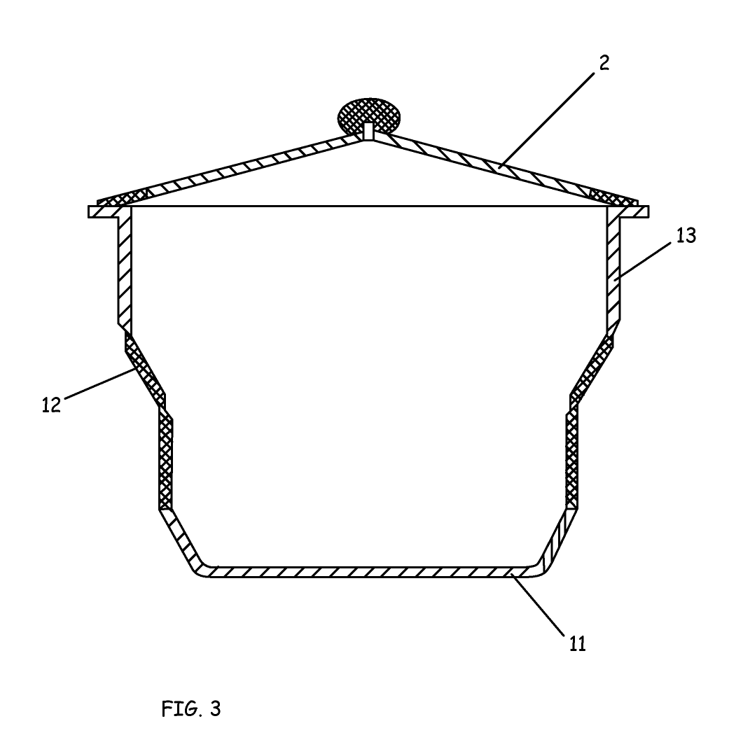

Referring to FIGS. 1 to 3, the foldable silicone pot 10, comprises a pot cover 2 and pot body 12, the pot body 12 is comprised of a silicone material and a lower end or bottom of the pot is comprised of a thermally conductive substrate such as aluminum or stainless steel. The lower end of the pot body is fixedly connected with the thermally conductive base 11 and the pot body 12 may be substantially an annular silicone wall 12. An upper end of the wall 12 provides a pot opening which has a border 13 where the border comprises a metal ring attached to the upper edge of the annular wall to provide stability to the pot in an expanded state. The annular or cyclic silicone wall 12 is fixedly connected at its lower end to an upper end of the bottom 11 of the pot which may be comprised of a thermally conductive stainless steel substrate in the shape of a circular disc, which terminates around the body 12 outwardly to open a funnel-shaped ramp surface. The stainless steel bottom pot body base 11 can guarantee hardness, strength and heat resistance, thermal conductivity to the bottom 11. The connection between the annular wall 12 pot body 12 and silicone pot opening frame 13 may comprise an adhesive forming a fixed edge. Adhesive is used to ensure the reliability of the connection and to prevent ease separation of the components from the thermal bottom 11 with ceramic or metal materials, mainly those used to conduct heat and styling and from which the pot opening frame 13 is constructed. The opening frame 13 may be constructed of a ceramic, metal or plastic material, or similar material. The cover or lid 2 is comprised of a transparent material such as glass. A least a portion of the glass, for example, the edge of the cover glass may be coated with a silicone seal layer and the top of the silica glass cover is fixed to the handle.

The thermally conductive substrate 11 and the annular wall 12 are secured or fixed to one another and this may be done using silicone adhesives. The annular wall 12 comprising the thermally conductive silicone substrate is provided with a bilateral wavy tooth structure on the card edge contact, the wave-shaped tooth structure of the card is a smooth transition arc tooth card and is provided with a corresponding card with wavy tooth structure with a groove structure of the annular wall of silica gel. The structure corresponding to the groove is provided with an undulating friction strip, the wavy card tooth structure and groove structure with the formation of a larger area of the contact surface, so that the thermal conductivity of the bottom wall 11 and a cyclic silicone adhesive is connected to provide a more stable pot, while avoiding thermal heating bottom 11, so that silica connected annular wall 12 does not deform when filled with liquid such as water. Tests show that the use of such a connection structure such that thermal heat transfer between the bottom 11 and the durable silicone annular wall 12 increased by a rate of more than 65%. In the actual production process, in the conventional bonding structure, overall defective product accounted for 4.8% of the product where defective means a failure rate of 64%. The adhesive structure with the use of wave-shaped structure, the failure wide product accounted for only 0.8% of the overall broad product, where the failure rate which accounted for 45%.

The annular wall 12 is fixedly connected with the silicone pot rim opening 13, using a combination of adhesive and shape. The opening 13 is provided on the upper edge of the frame of the cyclic silicone wall with the body 12 such that the body 12 is foldable to bring the rim opening 13 closer to the bottom 11. Unilateral Z-shaped teeth are positioned on the upper end of the body 12 and corresponding teeth are positioned on the opening border 13, the teeth of the tooth portion have an upward tilt, such that the silicone ring is provided with a wall facing the Z-shaped cards and matching the tooth structure on the upper edge of the body 12, and an adhesive is applied to this increased surface area between the rim 13 and the body 12 such that the connection is more stable, and when the pot is extending, into the “pot shape” for holding water or other liquid, the Z-shaped retaining tooth structure can withstand a certain vertical physical pull force, so that there is a more stable connection. Tests show that the use of such a connection structure makes the pot more durable and the connection rate increased by more than 35%. In the actual production process, the conventional bonding structure, overall defective product accounted for 4.8% of the product, including where the failure rate is 32%. Using adhesive structure Z-shaped card tooth structure, failure products accounted for 2.2% of the overall product, including where the failure rate of 14.5%.

In order to ensure a sealing silicone pot, and an easy to process (make) pot, the annular wall 12 is produced by an injection molding process such that the wall 12 is a silicone injection molded piece that is an integrally flexible silicone wall.

In order to fold the annular wall 12 of silica for a more structured and orderly shape, the annular wall 12 comprises a silica layer including a thick-walled and thin-walled layer that has a deformation capability. The thick layer and the thin wall layer are connected in intervals, in the folded state, the thick layer extending substantially maintain the original state, thin-walled layer is deformed to connect the shelves.

Silica gel thin-walled wall layer and the thick wall layer are provided on one piece of lines, the lines are surrounded by a closed loop of a wave pattern, where the highest point of the lines and the lowest point of the lines are respectively adjacent upper and lower ends of the thick-walled or thin-walled layer in the layer. Thus, the thin layer or a thick layer can maintain a certain strength, to maintain a cyclic structure, are not easily wrinkled or collapsed, thereby facilitating a better fold.

In order to facilitate folding the thin wall layer, the thin wall of the annular wall silicone layer in a state where natural expansion goes big, small, bucket, to cone-like structure, preferably, the difference between the radius of the conical upper and lower ends of 3-5 mm thin wall thickness, so that the thin wall layer can be more smoothly folded, and does not affect the overall structural strength.

Further, in order to make the silicone pot in the folded state of the inner layer to form a complete cavity structure, the annular wall having the thermally conductive silicone bottom portion is set to connect to a thick layer, the layer of the thick-walled the annular wall on silica gel at a maximum height of the thick layer.

In order to make a thick layer in the folded state so that the layers are smoothly set from the cyclic silicone wall in the lower edge radius is larger than the top of a thick layer of thick layers located below the upper edge of radius, in order to facilitate the folding, its radius difference in 2-4 mm thick wall thickness is better, at this time the smoothest silicone pot folded.

In order to facilitate movement of the silicone pot and prevent hand burns, the opening of the pot on the rim 13 also has a handle fixedly provided with a heat insulating layer.

Of course, in addition to the above-described embodiment, there may also be other variations on the structure of such equivalent technical solution should be within its scope of protection.

What is claimed:

1. A foldable silicone pot, including a pot body, wherein the pot body comprises a foldable annular silicone wall which is connected at a lower end to a thermally conductive substrate base, wherein the substrate base is fixedly connected to the foldable annular silicone wall and wherein the silicone wall is also fixedly secured to an outlet rim at its upper end, wherein the outlet rim provides an opening and stability to silicon pot when expanded.

2. The pot according to claim 1, wherein the annular wall is an integrally injection-molded flexible silicone wall comprised of silica gel.

3. The pot according to claim 1, wherein the annular silicone wall comprises a thick layer and a thin wall layer, the thick layer and the thin wall connected to an interlayer spacing providing the wall with foldability.

4. The pot according to claim 3, wherein the annular wall in the thin layer of a natural expanded state fits into a bucket cone-like structure.

5. The pot according to claim 2, wherein the annular wall and thermally conductive substrate base are connected such that the base is connected to a thick layer portion of silicone, which is the thick layer of the silicone wall on the maximum height of the thick layer.

6. The pot according to claim 2 wherein a radius at the lower edge of the top of a thick layer of silica gel on the annular wall is greater than in a thick layer on the bottom edge radius.

7. The pot according to claim 1, wherein the rim of the pot is constructed of a metal and wherein at least one handle is fixed to the metal rim.

8. The pot according to claim 7, wherein the handle comprises a thermal insulation layer such as a silicone layer.

9. The pot according to claim 1, and further comprising a pot cover, wherein the pot cover comprises a transparent glass cover and at least a portion of glass cover is coated with a silicone seal layer and the glass cover has a silicone handle.
